(19) United States
(12) Patent Application Publication
(10) Pub. No.: US 2026/0208580 A1
(43) Pub. Date: Jul. 23, 2026

(54) VEHICLE INFOTAINMENT SYSTEM PROVIDING UNIFIED PLATFORM AND HAVING WEB-WIDGETS

(71) Applicant: FCA US LLC, Auburn Hills, MI (US)

(72) Inventors: Amit Mehta, Auburn Hills, MI (US); Pravin V Chopade, Auburn Hills, MI (US)

(21) Appl. No.: 19/034,913

(22) Filed: Jan. 23, 2025

(51) Int. Cl. B60K 35/22; G06F 3/04817

(52) U.S. Cl. CPC B60K 35/22; G06F 3/04817; B60K 2360/164

(57) ABSTRACT

A vehicle information system for a vehicle includes a vehicle infotainment system and a control system. The vehicle infotainment system has a user interface including a display screen that displays a plurality of application icons. The control system includes a data storage unit and an electronic control unit. The control system is in communication with the user interface. The plurality of icons include a first icon associated with commerce, wherein the user selects the first icon and purchases a subscription service related to the vehicle; a second icon associated with entertainment, wherein the user selects the second icon and interacts with a game; a third icon associated with navigation, wherein the user selects the third icon and interacts with a navigation feature; and a fourth icon associated with a phone, wherein the user selects the fourth icon and interacts with a cellular telephone associated with the user.

### FIELD

The present application generally relates to vehicle infotainment systems and, more particularly, to a vehicle infotainment system that facilitates the integration and delivery of various digital services, providing a cohesive and enhanced user experience.

### BACKGROUND

Traditional in-vehicle entertainment systems primarily focus on providing audio and video content for the driver and other vehicle passengers. Modern vehicles are increasingly becoming hubs of digital activity, requiring advanced systems to deliver seamless, personalized experiences to drivers and passengers. Traditional in-vehicle systems often lack the flexibility and functionality to integrate a diverse range of digital services and applications efficiently. The absence of a unified platform for managing and delivering these services results in a fragmented user experience, limited interactivity, and underutilized potential for in-vehicle entertainment, navigation and personalization. Additionally, the difficulty in updating and adding new features to the in-vehicle system can lead to outdated and less engaging user experiences over time. Accordingly, while such in-vehicle entertainment systems do work well for their intended purpose, there is a desire for improvement in the relevant art.

### SUMMARY

According to one example aspect of the invention, a vehicle information system for a vehicle includes a vehicle infotainment system and a control system. The vehicle infotainment system has a user interface including a display screen that displays a plurality of application icons. The control system includes a data storage unit and an electronic control unit. The control system is in communication with the user interface. The plurality of icons include a first icon associated with commerce, wherein the user selects the first icon and purchases a subscription service related to the vehicle; a second icon associated with entertainment, wherein the user selects the second icon and interacts with a game; a third icon associated with navigation, wherein the user selects the third icon and interacts with a navigation feature related to a potential destination of the vehicle; and a fourth icon associated with a phone, wherein the user selects the fourth icon and interacts with a cellular telephone associated with the user.

In some implementations, the vehicle infotainment system further comprises a fifth icon associated with customer feedback, wherein the user selects the fifth icon and provides first user feedback related to a topic.

In some implementations, the vehicle infotainment system further comprises a sixth icon associated with Geo-Caching, wherein the user selects the sixth icon and interacts with various landmarks and a related map.

In some implementations, the vehicle infotainment system further comprises a backend portion of a cloud-based system, wherein the backed portion includes a processor and memory with programming to: receive the first user feedback related to the topic; receive additional user feedback from other users related to the topic; categorize the first user feedback and the additional user feedback; and provide a feedback count which is stored at the backend indicative of the categorization and making product improvement, AI based personalization based on the customer feedback.

In some implementations, the subscription service related to the vehicle includes a remote start function related to the vehicle.

In additional aspects, the subscription service related to the vehicle includes a maintenance reminder function related to the vehicle.

In additional features, the subscription service related to the vehicle includes an active vehicle performance function related to the vehicle.

In examples, the subscription service related to the vehicle includes an active safety and security function related to the vehicle.

In additional features, the subscription service related to the vehicle includes an active navigation function related to the vehicle.

In other features, the subscription service related to the vehicle includes an active 4G Wi-Fi hotspot related to the vehicle.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a diagrammatic view of a system providing a unified system having a platform that enables web-widgets according to various principles of the present application;

FIG. 2 is a diagrammatic view of a vehicle that defines part of the system of FIG. 1 according to examples of the present application;

FIG. 3 is a diagrammatic view of a vehicle control system having a vehicle infotainment system which may define part of a frontend portion of the system according to examples of the present application;

FIG. 4 is a schematic illustration of an exemplary head unit that implements the system in the vehicle of FIG. 2 according to examples of the present application;

FIGS. 5 and 6 are representative screenshots from a display of an in-vehicle infotainment system that incorporates web-widget applications which may define part of a frontend portion of the system;

FIG. 7 is a representative screenshot from a display of an in-vehicle infotainment system reflecting a selection of the “Digital Store” web-widget of FIG. 5 and that may define part of the frontend portion of the system;

FIG. 8 is a representative screenshot from a display of an in-vehicle infotainment system reflecting a selection of the “Games” web-widget of FIG. 5 and that may define part of the frontend portion of the system;

FIG. 9 is a representative screenshot from a display of an in-vehicle infotainment system reflecting a selection of the “Geo Caching” web-widget of FIG. 5 and that may define part of the frontend portion of the system;

FIG. 10 is a representative screenshot from a display of an in-vehicle infotainment system reflecting a selection of the “The Dyrt” web-widget of FIG. 5 and that may define part of the frontend portion of the system;

FIG. 11 is a representative screenshot from a display of an in-vehicle infotainment system reflecting a selection of the “Customer Feedback” web-widget of FIG. 5 and that may define part of the frontend portion of the system; and

FIG. 12 is a representative screenshot visible on the backend portion of the system reflecting a customer feedback sentiment analysis summary and visualization for all customers related to the “Customer Feedback” web-widget of FIG. 5.

### DESCRIPTION

As discussed above, traditional in-vehicle systems often lack the flexibility and functionality to integrate a diverse range of digital services and applications efficiently. The absence of a unified platform for managing and delivering these services results in a fragmented user experience, limited interactivity, and underutilized potential for in-vehicle entertainment, navigation and personalization. Additionally, the difficulty in updating and adding new features to the in-vehicle system can lead to outdated and less engaging user experiences over time.

The contemporary automotive landscape is shifting toward integrating advanced digital functionalities within the vehicle to enhance the overall driving and passenger experience. However, the existing in-vehicle systems are plagued with several significant issues that prevent them from fully meeting the evolving expectations of users. Firstly, the current in-vehicle systems are characterized by a fragmented user experience. They typically consist of isolated applications and services, each operating independently with little to no integration. This fragmentation leads to a disjointed user interface where information and entertainment services are not seamlessly delivered, causing inconvenience and frustration for users. For instance, switching between navigation, music, and other applications can be cumbersome, disrupting the driving experience.

Secondly, these systems lack advanced personalization capabilities. The inability to tailor content and services to the individual preferences and behaviors of users results in a generic and less engaging experience. Drivers and passengers today expect their in-vehicle environment to adapt to their unique needs, offering personalized recommendations and services that enhance convenience and enjoyment.

Furthermore, the integration of diverse digital services such as navigation, entertainment, and commerce into a single cohesive platform poses a significant challenge. Existing systems often fail to provide a unified interface that allows users to access and manage these services efficiently. This lack of integration not only diminishes the user experience but also limits the potential for leveraging these services to create a more connected and enjoyable in-vehicle environment.

Another critical issue is the complexity involved in updating and expanding the features of traditional in-vehicle systems. The process of adding new functionalities or updating existing ones is often labor-intensive and time-consuming, leading to vehicles quickly becoming outdated as new technologies and services emerge. This rigidity prevents the adoption of the latest innovations and hinders the continuous improvement of the user experience.

Additionally, there is a significant underutilization of data analytics and artificial intelligence in enhancing in-vehicle experiences. Traditional systems do not effectively leverage artificial intelligence, machine learning (AI-ML) capabilities to analyze user data and provide personalized recommendations or improvements. The lack of advanced analytics and AI integration means that valuable insights into user behavior and preferences are not utilized to their full potential, resulting in missed opportunities for creating a more intuitive and responsive in-vehicle environment.

The instant disclosure provides a system having a vehicle infotainment system that facilitates the integration and delivery of various digital services, providing a cohesive and enhanced user experience. The system described herein provides an application market or “AppMarket” having a plurality of web-widgets applications. The system provides a platform that revolutionizes the in-vehicle system by providing an integrated, personalized, and adaptable user experience along with safety. As will become appreciated herein, the web-widgets serve as the foundational capability for integrating various digital services into a single cohesive interface. The web-widgets enable streamlined access to navigation, personalized notification, and search functionalities for points of interest, all through voice-activated and manual commands. This ensures that users can interact with the system effortlessly, enhancing both convenience and safety.

The system architecture includes a user-facing software program (such as an Android application) with a web view on a head unit that is connected to a hypertext transfer protocol (HTTP) Application web server hosted on a cloud server. This ensures real-time interactions and updates, maintaining a current and engaging user experience. An application programming interface (API) gateway facilitates secure and efficient communication between the Cloud HTTP server and the Android app, ensuring that all system components work harmoniously.

As described in further detail below, the system provides a diverse range of applications, including ‘Digital Store/Wallet,’ ‘Games,’ ‘Geocaching,’ ‘Dyrt,’ ‘RevKit,’ ‘Yelp/Simple Night,’ ‘Customer Feedback,’ and ‘ChatGPT,’ ‘LBDSS’, that are integrated into the platform. These applications cater to various needs, from entertainment to commerce and feedback, providing a comprehensive in-vehicle experience. The Digital Storefront feature enables users to purchase subscriptions and access vehicle features using stored payment information, seamlessly integrating commerce into the in-vehicle environment. The platform also enhances entertainment options through features like casual games that can be played alone or with other passengers while waiting at charging stations or during idle times. This not only entertains passengers but also makes wait times more enjoyable.

The system further integrates AI-ML based Personalized Learning and Vehicle-Customer Modeling (PLVCM) that transforms how user data is utilized. The platform leverages AI-ML algorithms to analyze real-time and offline user interaction data, providing personalized recommendations and insights. This capability ensures that the system adapts to individual preferences and behaviors, continually enhancing the user experience.

Existing in-vehicle systems are often limited by a number of critical issues such as, but not limited to, fragmented user experience, limited personalization, inadequate integration of digital services, complexity of updates and feature expansion and lack of advanced analytics and AI integration. The instant application provides advantages over such existing in-vehicle systems by providing a unified web-widget architecture, seamless integration and communication, a diverse range of applications, a digital storefront and subscription management, enhanced entertainment options, and AI-ML based personalization and analytics.

Existing in-vehicle systems provide a fragmented user experience. In particular, existing in-vehicle systems provide a standalone in-vehicle infotainment system that provides basic functions with minimal integration. Mobile device integration relies on smartphones for functionality, leading to a fragmented experience. Original equipment manufacturers provide specific solutions provide proprietary systems with limited third-party integration. Aftermarket systems can require complex installation with compatibility issues. Connected navigation systems are focused primarily on navigation. The system described herein provides a unified platform that integrates a wide range of digital services (navigation, entertainment, commerce, communication, vehicle service, vehicle health, etc.) into a single cohesive platform, ensuring users can access all necessary features without switching devices or systems. Web-widgets are provided that provide a streamlined interface that combines multiple functionalities, making user interaction more straightforward and efficient.

Existing in-vehicle systems provide only basic personalization that is limited to simple user preferences with minimal use of AI-ML. The personalization is inconsistent and lacks comprehensive, data-driven personalization features. The system described herein provides AI-ML based personalized learning and vehicle-customer modeling (PLVCM) that utilizes advanced AI-ML algorithms to analyze user behavior and preferences, providing highly tailored recommendations and services. Personalized notifications and messages are provided that enhance user experience by offering relevant and timely information based on individual preferences and behaviors.

Existing in-vehicle systems provide integration challenges that struggle to integrate diverse digital services efficiently. Such existing systems provide limited interoperability that can be restricted to proprietary or specific third-party applications. The system described herein provides an API gateway that facilitates seamless integration between the cloud server and the in-vehicle Android application, enabling efficient management and secure access to a wide range of digital services. The system described herein further provides comprehensive integration that integrates with multiple services, including third-party application, enhancing system versatility and functionality.

The system described herein provides scalability and flexibility in updates and feature expansion. Existing in-vehicle systems are rigid and difficult to expand, leading to quickly outdated technologies. Manual updates are often required that need physical intervention or dealership visits for updates. The system described herein provides a cloud-based architecture and modular design. The cloud-based architecture enables easy updates and addition of new features without physical intervention, keeping the in-vehicle environment current with technological advancements. The modular design allows for flexible expansion and addition of new services, ensuring scalability.

The system described herein leverages data analytics for enhanced insights. Previous solutions underutilized data providing a limited use of in-vehicle data for enhancing user experiences. Previous solutions further used basic feedback mechanisms without comprehensive data analysis. The system described herein uses advanced data analytics and AI integration. The system analyzes user interaction data to provide valuable insights and personalized recommendations, significantly enhancing the overall user experience. The system further collects and analyzes customer feedback using AI to continuously improve and personalize services.

The system described herein provides enhanced in-vehicle commerce opportunities. Previous solutions provided limited commerce integration that restricted opportunities for in-vehicle purchases and subscriptions. Prior solutions further provided a fragmented commerce experience where users rely on external devices or systems for digital commerce. The instant disclosure provides a digital store/wallet that allows users to purchase access and subscriptions to vehicle features directly from the vehicle, creating new revenue streams and enhancing convenience. With the integrated AppMarket, users can access and subscribe to various applications seamlessly, providing a streamlined commerce experience.

The system described herein provides improved safety and convenience. Previous solutions provided only basic safety features with limited advanced features to enhance safety and convenience. Furthermore, previous solutions provide manual controls that predominately rely on manual interaction, detracting from safety. The present system provides voice-activated controls and real-time data analysis. The voice-activated controls reduces the need for manual interaction, enhancing safety. Real-time data analysis provides users with timely and relevant information, improving convenience and decision making.

The system described herein provides engagement and entertainment during idle times. Previous solutions provide limited engagement features that did not fully capitalize on opportunities to engage and entertain users during idle times. The present system provides engaging activities (such as in-car games and geocaching) for passengers during idle times, enhancing the overall in-vehicle experience.

The system described herein provides customer feedback and continuous improvement. Previous solutions provide limited feedback mechanisms and minimal data analysis. With limited feedback mechanisms, there are missed opportunities for continuous improvement based on customer feedback. With minimal data analysis, feedback is not comprehensively analyzed for actionable insights. The present system provides a customer feedback feature that collects customer feedback and uses AI to analyze it, enabling continuous improvement of the system based on real user experiences and preferences.

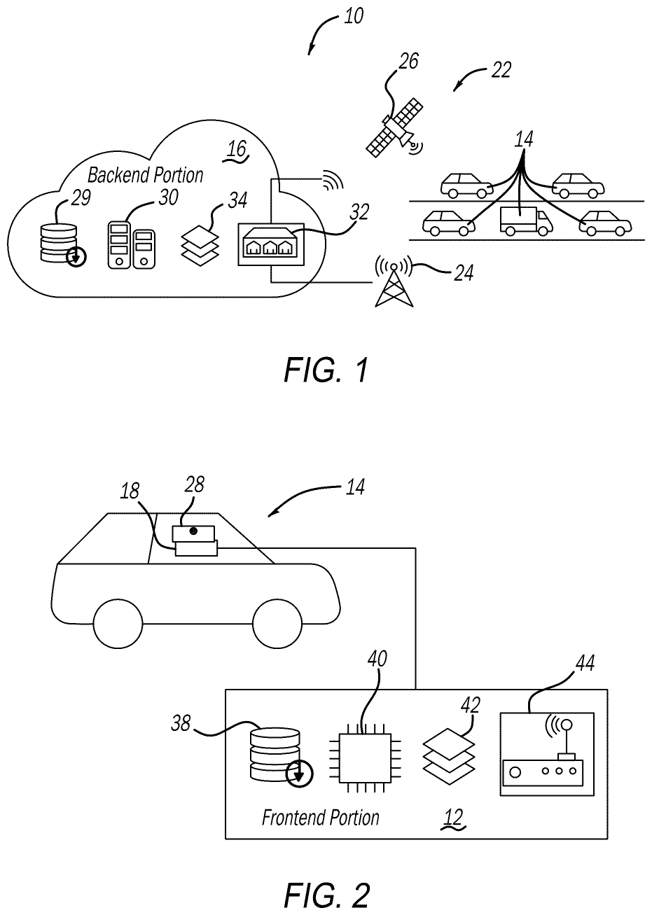

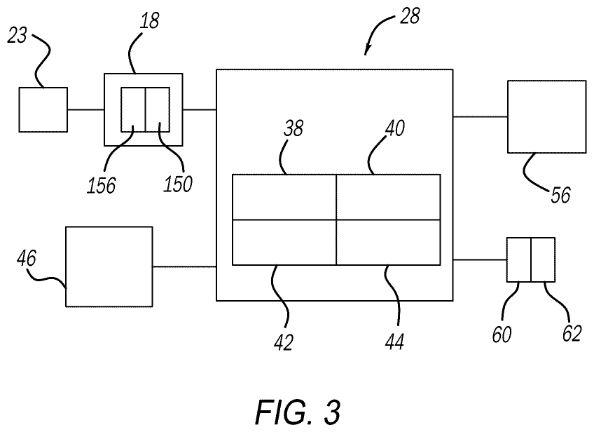

Referring in more detail to the drawings, FIGS. 1 and 2 illustrate a vehicle information system 10 including a frontend portion 12 with one or more network vehicles 14 that are in communication with a backend portion 16 via one or more communication devices and suitable communication protocols. The network vehicles 14 include in-vehicle infotainment (IVI) system 18 (FIG. 3) that utilize a combination of software and hardware components to provide a wide range of information, system controls and entertainment to a user 23. As shown in FIG. 3, the IVI system 18 may include one or more display screens 20 and a user interface 21.

With reference to the schematic block diagrams of FIGS. 1 and 2, the vehicle information system 10 may be a cloud-based system that may receive incoming information from individual ones of the network vehicles 14 and send outgoing information to multiple network vehicles 14, wherein the outgoing information may include mass notifications that are the same for multiple vehicles or individual notifications that are each specific to the vehicle to which each individual notification is sent. The system 10 may gather real-time information from network vehicles 14 to use for comprehensive data analytics.

The term “real-time”, as used herein, does not strictly require that such information and notifications be generated, sent, received and/or otherwise processed at the exact moment when their underlying events or conditions occur in order to be “real-time”. Rather, these terms broadly include any such information and notifications that are generally contemporaneous with their underlying events or conditions so that the environmental conditions information and notifications are still relevant or accurate in the context of the present system and method.

The system 10 may deliver hosted services via the internet and/or other communication networks and may be structured as a public, private or hybrid cloud, for example. According to one non-limiting example, vehicle information system 10 is structured as a private cloud and generally includes the backend portion 16 and the frontend portion 12 that is distributed across a fleet of network vehicles 14, where each network vehicle 14 is capable of obtaining and providing information as well as communicating with the backend portion 16 over a secure communications network 22 (e.g., secure vehicle-to-cloud (V2C) network).

The secure communications network 22 may include a cellular-based network 24, a satellite-based network 26, a city-wide Wi-Fi-based network, some other type of communications network and/or a combination thereof. Although only a few network vehicles 14 are shown in the drawings, it should be appreciated that system 10 may interact with a large fleet of vehicles that can include dozens, hundreds, thousands or even more vehicles. System 10 may be used with any vehicles, including (but not limited to) passenger, commercial and/or public transportation vehicles sold in any geographic area.

Backend portion 16 may include any suitable combination of software and/or hardware resources typically found in a backend of a cloud-based system, as best illustrated in FIG. 1. The backend portion 16 may be responsible for managing some of the programs and algorithms that run applications on the frontend portion 12, such as those that request, obtain and optionally analyze information of and from the network vehicles 14. It is noted that the data/information used to formulate recommendations may be analyzed by control systems 28 and processors on-board a network vehicle 14 or by the backend portion 16 or both, as desired. The backend portion 16 may be managed or controlled by the vehicle manufacturer and can be part of a larger cloud-based system that the vehicle manufacturer uses to communicate and interact with a large fleet of vehicles for a multitude of purposes. For example, the backend portion 16 may include or communicate with emergency alert systems, such as those that provide Amber alerts or other missing persons alerts, or law enforcement systems that may provide and receive information regarding vehicles of interest to them.

The backend portion 16 may include any suitable combination of software and/or hardware resources including, but not limited to, components, devices, computers, modules and/or systems such as those directed to applications, service, storage, management and/or security (each of these resources is referred to herein as a “backend resource,” which broadly includes any such resource located at the backend portion 16). In one example, the backend portion 16 has a number of backend resources including data storage systems 29, processors or servers 30, communication systems 32, programs and algorithms 34, as well as other suitable backend resources. It should be appreciated that backend portion 16 is not limited to any particular architecture, infrastructure or combination of elements, and that any suitable backend arrangement may be employed.

Frontend portion 12 may include any suitable combination of software and/or hardware resources typically found in a frontend of a cloud-based system, as shown in FIG. 2, and is generally responsible for sending information to the backend portion 16 and receiving notifications, programs, instructions and the like from the backend portion 16. Depending on the particular arrangement, the frontend portion 12 may also be responsible for gathering camera, sensor, location and/or other data from devices on the vehicle 14 and sending such information to the backend portion 16.

The frontend portion 12 is typically responsible for running the applications that interface with the users in the different vehicles 14, and for interfacing with the programs and algorithms 34 of the backend portion 16. The frontend portion 12 may also be managed or controlled by the vehicle manufacturer and can be part of a larger cloud-based system that the vehicle manufacturer uses to communicate and interact with a large fleet of vehicles for various purposes, as mentioned above. The frontend portion 12 may be distributed across one or more vehicles 14 and may include any suitable combination of software and/or hardware resources including, but not limited to, components, devices, computers, modules and/or systems (each of these resources is referred to herein as a “frontend resource,” which broadly includes any such resource located at the frontend portion 12).

In one example, the frontend portion 12 has a number of frontend resources including a vehicle control system 28 having one or more vehicle electronic module(s) installed in vehicles 14, which may include some combination of a data storage unit 38, an electronic control unit and/or processor(s) 40, applications 42, a communications unit 44 (e.g., one that includes a telematics unit and/or other communication devices with a receiver by which information is received at unit 44 and a transmitter by which information is sent from the unit 44), as well as other suitable frontend resources.

The backend portion 16 may include one or more AI/ML algorithms 34 for personalized learning and vehicle-customer modeling, to analyze data and provide customized recommendations for users based on their preferences, usage patterns and behaviors, and taking into account information from groups of users as is determined to be relevant.

The control system 28 may be or include a telematics control module (TCM), a telematics box module (TBM), a body control module (BCM), an electronic control unit (ECU), an infotainment control module, or any other suitable module known in the art. It is not necessary for the preceding units to be packaged in a single vehicle electronic module, as illustrated in FIG. 2; rather, they could be distributed among multiple vehicle electronic modules, they could be stand-alone units, they could be combined or integrated with other units or devices, or they could be provided according to some other configuration. It should be appreciated that frontend portion 12 is not limited to any particular architecture, infrastructure or combination of elements, and that any suitable frontend arrangement may be employed.

In order to perform the functions and desired processing set forth herein, as well as the computations therefore, the control system 28 may include, but is not limited to, one or more controller(s), control unit(s), processor(s), computer(s), DSP(s), memory, storage, register(s), timing, interrupt(s), communication interface(s), and input/output signal interfaces, and the like, as well as combinations comprising at least one of the foregoing, as generally described with regard to the frontend portion 12. For example, the control system 28 may include input signal processing and filtering to enable accurate sampling and conversion or acquisitions of such signals from communications interfaces and sensors. As used herein the terms control system 28 may refer to one or more processing circuits such as an application specific integrated circuit (ASIC), an electronic circuit, a processor (shared, dedicated, or group) and memory that executes one or more software or firmware programs, a combinational logic circuit, and/or other suitable components that provide the described functionality. The control system 28 may be distributed among different vehicle modules, such as an infotainment control module, engine control module or unit, powertrain control module, transmission control module, and the like, if desired, and the memory and one or more processors may be one or both integrated into the vehicle 14 or remotely located and wirelessly communicated to the vehicle 14.

To enable control and monitoring of various vehicle operating, environmental and other conditions related to vehicle operation, the control system 28 may include or be communicated with a range of sensors 46, shown diagrammatically in FIG. 3. By way of some examples, the vehicle 14 may include: a speed sensor that provides an indication of vehicle speed; one or more accelerometers responsive to vehicle accelerations in various directions and orientations; wheel speed sensors responsive to the rotational speed of the vehicle wheels; drive input sensors that sense the position and/or rate of movement of the throttle, brake and/or steering inputs; position or location sensors or devices (such as GPS or the like) to determine the location of the vehicle; temperature sensors for various things like ambient temperature, engine/motor temperature, and the like; fuel level sensor; battery sensor (voltage, charge level, or the like); an odometer; tire pressure sensors and other sensors that may be responsive to or useful in controlling vehicle operation (e.g. current draw of motors, torque sensors, steering sensors, etc.); an in-vehicle microphone for recording audio from an occupant. The vehicle may include object detection sensors like cameras, radar, lidar and other sensors, and these sensors may provide information about the vehicle and the surrounding environment.

Various navigation programs 56 (FIG. 3) are known that compute a travel path to a destination, and convey information about the travel path to a driver in the form of visual and/or audible instructions for navigating the vehicle 14 along the travel path. The navigation programs can use information from the vehicle location sensor (e.g. GPS), a remote device location sensor (e.g. GPS chip of a smartphone in the vehicle) and map data and information relating to road conditions, speed limits, location of intersections and traffic signals, and the level of traffic (such as is available from Waze, Google Maps, TomTom maps, and other applications and sources). This information can be used to define travel paths that are shortest in total distance or time, or that avoid certain road types.

Further, user data 60 may include preferences of the user that may be input into the system 10 by the user, for example via an internet interface on a remote device 62 (e.g. phone, tablet, computer), or learned by the information system based upon user interaction with the vehicle and IVI system 18 over time. The preferences can relate to, by way of non-limiting examples, fuel brands, restaurants, hotels, vehicle service centers, car accessory brands or type, music/entertainment/social media, hobbies, retail stores, stocks, sports teams, preference for paid or free services and applications, and other information. User data 60 may also include interaction information such as prior sales or purchase information, call center interactions, social media activity and other information.

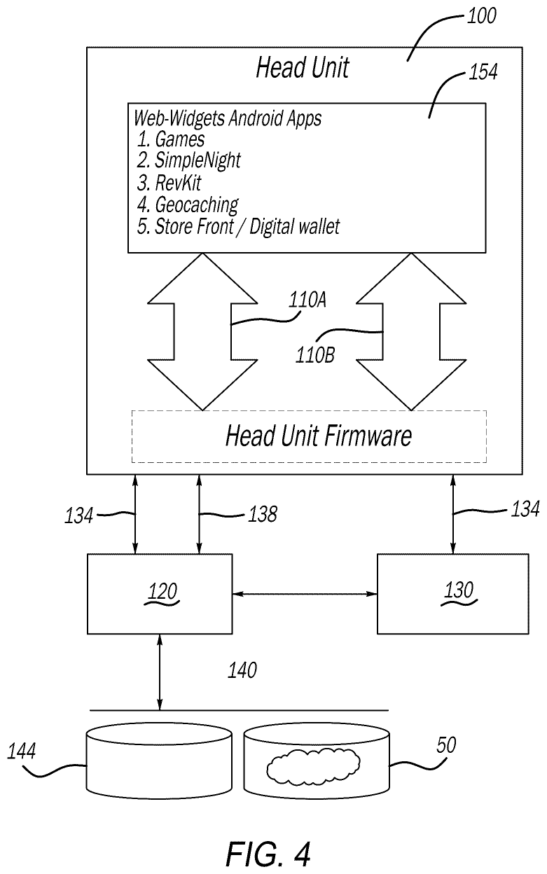

Turning now to FIG. 4, additional features of the vehicle information system 10 will be described. FIG. 4 is schematic illustration of an exemplary head unit 100 that implements the vehicle information system 10 according to examples of the present application. The head unit 100 can communicate with firmware 106 by way of an application programming interface (API). A first application programming interface is identified at 110A. A second application programming interface is identified at 110B. The first programming interface 110A can be a first language, while the second programming interface 110B can be a second language. It is contemplated that one or many API's can be incorporated. The head unit 100 can communicate with a Telematics Box Module (TBM) 2.0, TMB 2.0H 120 and a body control module 130.

In examples, the head unit 100 can communicate with the TBM 2.0, TMB 2.0H 120 over a controller area network (CAN) 134. The TBM 120 acts as a modem providing internet connectivity to head unit 100 (a pass-through). Web Widget apps or icons 154 goes through Access Point Name (APN3) network protocol for data traffic server. The CAN 134 may include additional elements or features, which have been omitted for simplicity, such as controllers, buffers (cache) drivers, repeaters and receivers, among many others, to enable communications. Further, the CAN 134 may include address, control and/or data connections to enable appropriate communications among the components/systems described herein. The head unit 100 can additionally or alternatively communicate with the TBM 2.0, TMB 2.0H 120 through ethernet 138. The TBM 2.0, TMB 2.0H 120 communicates over a data traffic layer/website widget application programming interface gateway 140 to an eligibility layer data store 144 and the cloud 50. The head unit 100 and applications 154 collectively provide application programing interface for seamless integration with the vehicles audio, display and control systems.

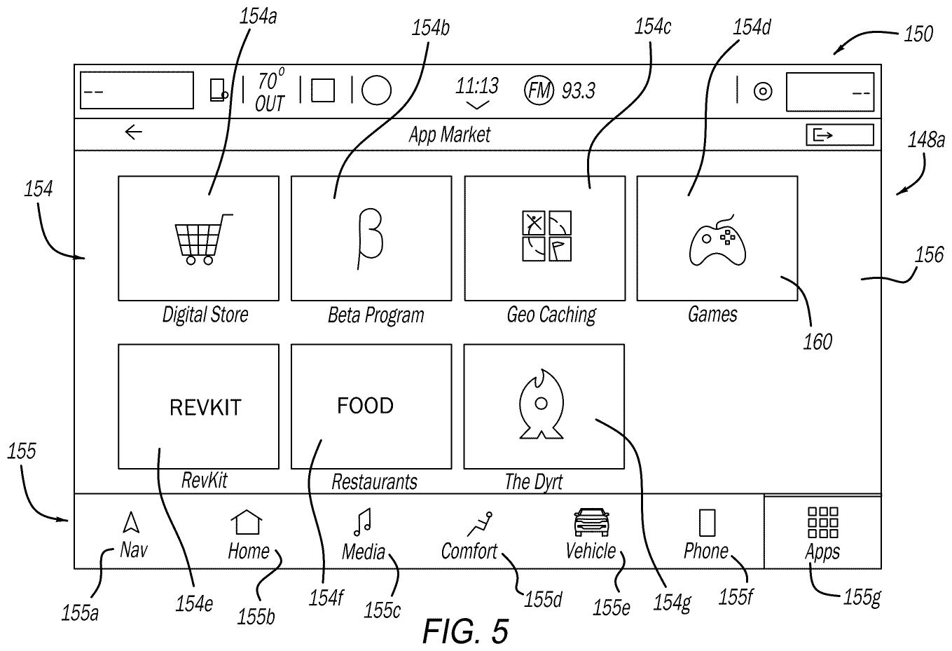

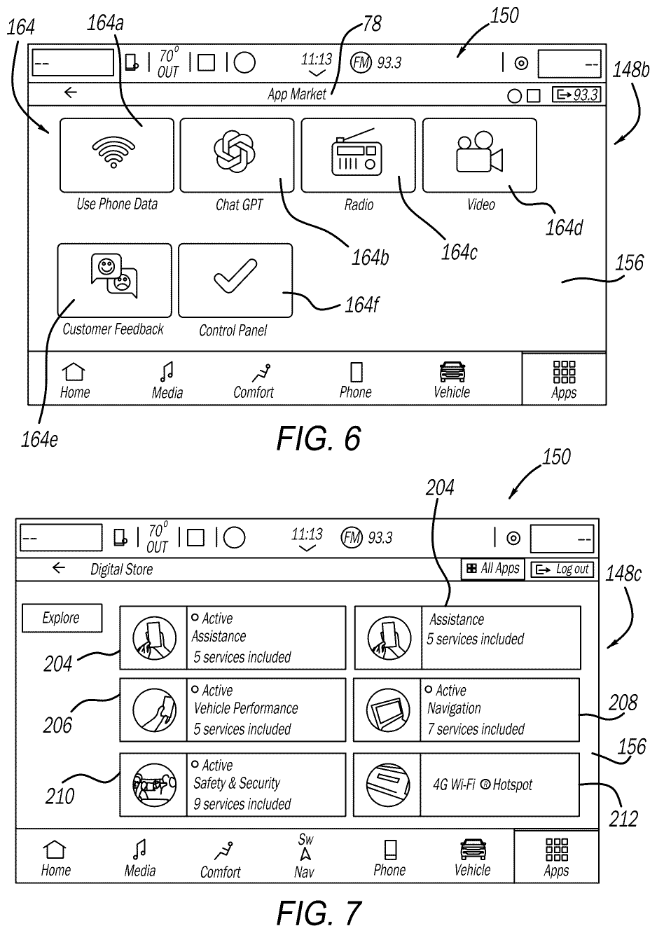

With additional reference to FIGS. 5 and 6, additional features of the system 10 will be described. As shown on FIG. 5, a screenshot 148a of the infotainment system 18 provides an in-vehicle user interface 150 shown implemented as a collage of general application Web-Widgets or first application icons 154 and second application icons 154 on a display 156 of the vehicle infotainment system 18. In examples, some of the web-widget applications can be included within an application market or “AppMarket” 78. With the integrated AppMarket, 78 users can access and subscribe to various applications seamlessly, providing a streamlined commerce experience.

In the example shown, the first application icons 154 include: a Digital Store icon 154a, a Beta Program icon 154b, a Geo-Caching icon 154c, a Games icon 154d, a RevKit icon 154e, a restaurants icon 154f, and a Dyrt™ icon 154g. The first application icons 154 are integrated into the platform. The applications cater to various needs, from entertainment to commerce and feedback, providing a comprehensive in-vehicle experience.

The second application icons 155 can be specific to the vehicle 14. In the example shown, the second application icons 155 include a navigation icon 155a, a home icon 155b, a media icon 155c, a comfort icon 155d, a vehicle icon 155e, a phone icon 155f and an apps icon 155g. Notably, the infotainment system 18 combines navigation (such as icon 155a), entertainment (such as all icons related to the first application icons 154, the second application icons 164 and/or the media icon 155c), communication (such as icon 155f), and commerce (such as the Digital Store icon 154a) into a single unified and cohesive platform.

The Web-Widgets 154, 155 serve as the foundational capability of integrating various digital services into a single, cohesive interface. The Web-Widgets 154, 155 enable streamlined access to navigation, personalized notifications, and search functionalities for points of interest, all through both voice-activated and manual commands. This ensures that the user 23 can interact with the system 10 effortlessly, enhancing both convenience and safety.

The Digital Store icon 154a allows a user 23 to purchase access and subscriptions to vehicle features directly from the vehicle 14. In this regard, users 23 can access and subscribe to various applications seamlessly. By way of example, such subscription services can include remote start functionality, a maintenance reminder function related to the vehicle, and other monitoring features. In examples, the user can have payment information stored.

FIG. 6 shows a screenshot 148b of the display 156 subsequent to selection of the Beta Program app 154b which includes additional icons 164 including a Use Phone Data icon 164a, a Chat GPT icon 164b, a Radio icon 164c, a Video icon 164d, a Customer Feedback icon 164e, and a Control Panel icon 164f.

FIG. 7 shows a screenshot 148c of the display 156 subsequent to selection of the Digital Store app 154a, with menu options for vehicle service and option subscriptions and related interfaces therefore, examples include Assistance 204, Vehicle Performance 206, Navigation 208, Safety and Securing 210 and Wi-Fi Hotspot 212 use. These items may include submenus and further information on additional screens, in a known manner. In this regard, the IVI system 18 may be used to manage subscriptions to various programs, features or options, and permit use of at least one programs, features, or options.

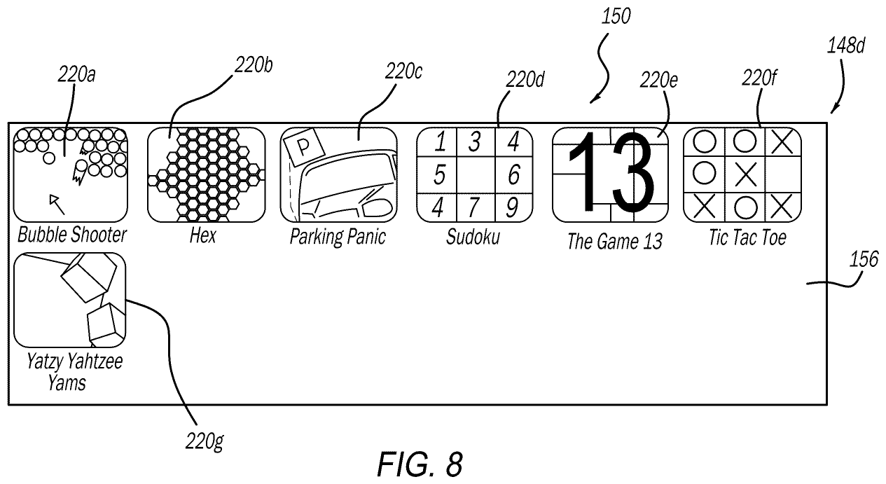

FIG. 8 shows a screenshot 148d of the display 156 subsequent to selection of the Games app 160, with menu options including various gaming icons collectively identified at 220. The exemplary icons 220 include Bubble Shooter 220A, Hex 220B, Parking Panic 220C, Sudoku 220D, The Game 13 220E, Tic Tac Toe 220F and Yatzy Yahtzee Yams 220G. Additional games may be provided and updated in real-time.

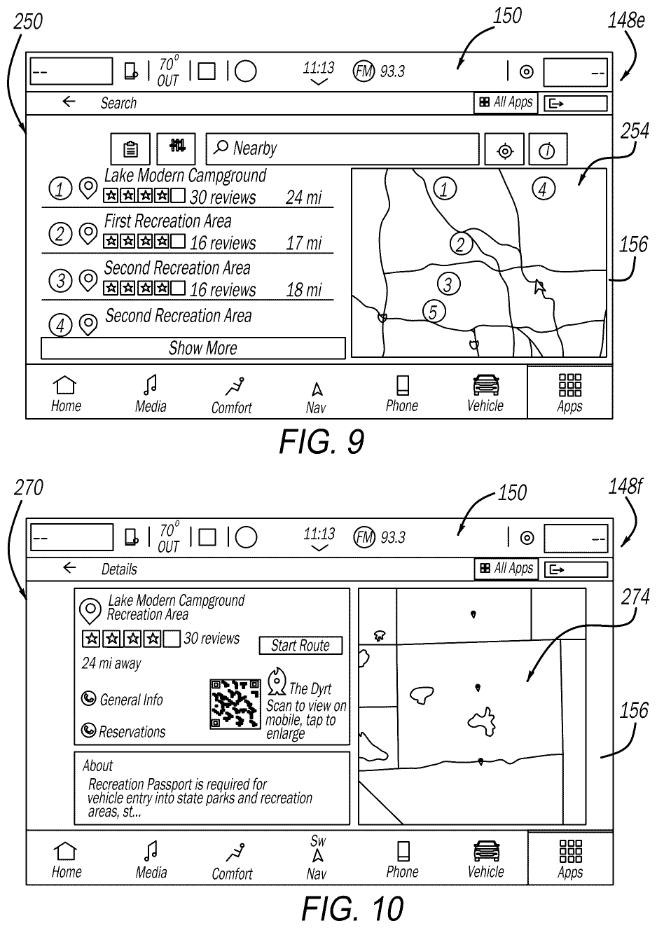

FIG. 9 shows a screenshot 148e of the display 156 subsequent to selection of the Geo-Caching app 154c. The Geo-Caching app 154c provides a collection of landmarks 250 and related locations of the landmarks 250 on a map 254.

FIG. 10 shows a screenshot 148f of the display 156 subsequent to selection of the Dyrt™ app 154g. The Dyrt™ app 156 provides various campground and trail landmarks 270 and related locations of the landmarks 270 on a map 274.

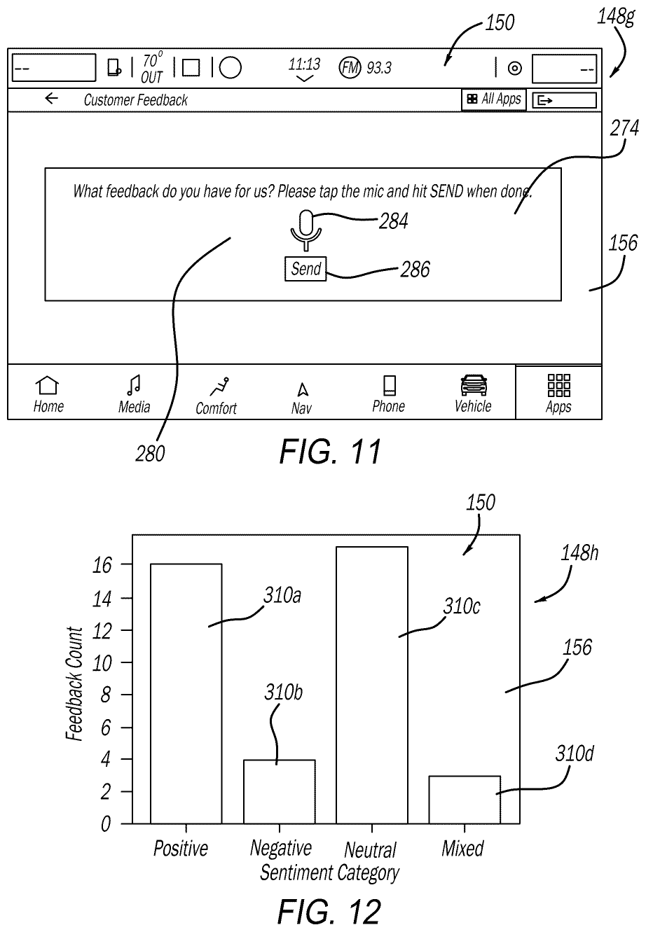

FIG. 11 shows a screenshot 148g of the display 156 subsequent to selection of the Customer Feedback app 164e. The customer feedback app 164n provides a feedback input icon 280 where a user can submit feedback related to a topic (a landmark identified in the Dyrt™ app 154g, etc.), such as an audio feedback. In the example shown, a microphone icon 284 may be selected at which point a user can provide audio commentary that is received by a vehicle microphone. Once complete, a user can select the send icon 286 where the audio file can be transmitted to the frontend portion 12 and/or the backend portion 16 for processing.

FIG. 12 is a representative screenshot visible on the backend portion of the system reflecting a customer feedback sentiment analysis summary and visualization for all customers related to the “Customer Feedback” web-widget of FIG. 5. The system compiles various customer feedback information regarding a particular topic, event, landmark, etc. In the example shown, the feedback from various customers is categorized as positive feedback 310a, negative sentiment 310b, neutral category 310c and mixed 310d. In one examples, the backend portion 16 receives the user feedback from the user 23 and from other various users related to a topic. The feedback is categorized and a feedback count is provided at the display 156 of the user interface 150 indicative of the categorization. In examples, the categorization is used for making product improvement, AI based personalization based on the customer feedback.

As used herein, the term controller or module refers to an application specific integrated circuit (ASIC), an electronic circuit, a processor (shared, dedicated, or group) and memory that executes one or more software or firmware programs, a combinational logic circuit, and/or other suitable components that provide the described functionality.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. A vehicle information system for a vehicle, the vehicle information system comprising:
a vehicle infotainment system having a user interface including a display screen that displays a plurality of application icons; and
a control system that includes a data storage unit and an electronic control unit, the control system being in communication with the user interface;
wherein the plurality of application icons include:
a first icon associated with commerce, wherein the user selects the first icon and purchases a subscription service related to the vehicle;
a second icon associated with entertainment, wherein the user selects the second icon and interacts with a game;
a third icon associated with navigation, wherein the user selects the third icon and interacts with a navigation feature related to a potential destination of the vehicle; and
a fourth icon associated with a phone, wherein the user selects the fourth icon and interacts with a cellular telephone associated with the user.

2. The vehicle information system of claim 1, wherein the vehicle infotainment system further comprises a fifth icon associated with customer feedback, wherein the user selects the fifth icon and provides first user feedback related to a topic.

3. The vehicle information system of claim 2, wherein the vehicle infotainment system further comprises a sixth icon associated with Geo-Caching, wherein the user selects the sixth icon and interacts with various landmarks and a related map.

4. The vehicle information system of claim 2, further comprising:
a backend portion of a cloud-based system, wherein the backend portion includes a processor and memory with programming to:
receive the first user feedback related to the topic;
receive additional user feedback from other users related to the topic;
categorize the first user feedback and the additional user feedback; and
provide a feedback count at the backend portion indicative of the categorization.

5. The vehicle information system of claim 1, wherein the subscription service related to the vehicle includes a remote start function related to the vehicle.

6. The vehicle information system of claim 1, wherein the subscription service related to the vehicle includes a maintenance reminder function related to the vehicle.

7. The vehicle information system of claim 1, wherein the subscription service related to the vehicle includes an active vehicle performance function related to the vehicle.

8. The vehicle information system of claim 1, wherein the subscription service related to the vehicle includes an active safety and security function related to the vehicle.

9. The vehicle information system of claim 1, wherein the subscription service related to the vehicle includes an active navigation function related to the vehicle.

10. The vehicle information system of claim 1, wherein the subscription service related to the vehicle includes an active 4G Wi-Fi hotspot related to the vehicle.
